(19) United States
(12) Patent Application Publication
(10) Pub. No.: US 2021/0055194 A1
(43) Pub. Date: Feb. 25, 2021

(54) THERMOGRAVIMETRIC/DIFFERENTIAL THERMAL ANALYSIS (TG/DTA) SIMULTANEOUS MEASUREMENT APPARATUS

(71) Applicant: SHIMADZU CORPORATION, Kyoto-shi (JP)

(72) Inventor: Toru TAKASHIMA, Kyoto-shi (JP)

(73) Assignee: SHIMADZU CORPORATION, Kyoto-shi, (JP)

(21) Appl. No.: 16/927,310

(22) Filed: Jul. 13, 2020

(30) Foreign Application Priority Data
Aug. 21, 2019 (JP) 2019-150817

(51) Int. Cl. G01N 5/04

(52) U.S. Cl. CPC G01N 5/04

(57) ABSTRACT

A TG/DTA simultaneous measurement apparatus includes a heating furnace; a placing section configured to receive, on its top portion, a tiny sample; a heating furnace moving section configured to move the heating furnace between a position where the placing section is housed in the heating furnace and a position where the placing section is exposed to the outside; and an operation assistance table made of a material having heat resistance, at the position lower than the position of the placing section, in front of the heating furnace, as viewed from an operator who operates the analyzer.

### TECHNICAL FIELD

The present invention relates to a thermogravimetric/differential thermal analysis (TG/DTA) simultaneous measurement apparatus.

### BACKGROUND ART

In the differential thermal analysis, a specimen sample and a reference sample are made to undergo thermal changes in accordance with a certain program while the temperature difference between the specimen sample and the reference sample is measured as a function of temperature. Transition, melting, reaction, and other phenomenon accompanying endothermic and exothermic reactions are observed in the measurement. Meanwhile, thermogravimetry is a method of measuring the change in weight of a sample when the sample is heated or cooled at a constant rate, or when the sample is held at a certain 20 temperature. Chemical or physical change that accompanies the weight change with respect to temperature is observed in the thermogravimetry. Examples of chemical and physical changes include vaporization, decomposition, oxidation, reduction, and adsorption. Apparatuses which can perform both differential thermal analysis and thermogravimetric analysis, and can simultaneously perform these analyses have been commercially available.

FIG. 4 is a perspective view of a TG/DTA simultaneous measurement apparatus disclosed in Non Patent Literature 1. The arrow directed to the lower left on the sheet indicates the front of the apparatus. This apparatus includes: in the lower part, a weight measurement section 3 for measuring the respective weights of a specimen sample and a reference sample; in the upper part, a heating furnace section 1 in which a heating furnace for heating the specimen sample and the reference sample is housed; and behind the heating furnace section 1, a heating furnace moving section 2 for moving the heating furnace section 1 upward and downward. Behind the heating furnace moving section 2, a controller 5 containing various electric circuits is provided. In the protruding portion on a casing of the weight measurement section 3 in front of the heating furnace section 1, a cooling section 4 is provided which includes a fan for cooling a connecting portion between the bottom of the heating furnace in the heating furnace section 1 and the weight measurement section 3.

Two pieces of detectors each shaped a small diameter rod extend from the weight measurement section 3 in a substantially vertical direction. Each of the detectors has, at its top end, a sample plate made of metal for placing a tiny sample. The sample plate on one of the detectors is used for placing a specimen sample to be measured, and a sample plate on the other one of the detectors is used for placing a reference sample when a differential thermal analysis is performed. A thermocouple is fixed to each of the sample plates, and the conduction wires are inserted in holes provided in the detector to reach the controller 5. The temperatures of a specimen sample and a reference sample on the sample plates are measured by the thermocouple. Meanwhile, the respective weights of the specimen sample and reference sample on the sample plates are measured by the weight measurement section 3.

Typical measurement process using the TG/DTA simultaneous measurement apparatus are as follows:

(1) An operator prepares a specimen sample to be measured. Specifically, an appropriate sample cell (container) according to the measurement method and so on are selected, and the specimen sample is put in the sample cell on an operation table. Then, alumina powder or the like are put in another sample cell that is the same type as the sample cell in which the specimen sample is put, so as to prepare a reference sample. The sample cell usually has a tiny flat-cylinder shape with several mm in diameter and 1 to 2 mm in height.

(2) Thereafter, when the operator performs a predetermined operation through an operation panel, the heating furnace moving section 2 moves the heating furnace section 1 upward to a position where the two sample plates are adequately exposed.

(3) The operator puts the specimen sample and the reference sample on the respective sample plates, using precision tweezers.

(4) When the operator performs a predetermined operation through the operation panel, the heating furnace moving section 2 moves the heating furnace section 1 downward, so that the sample plates on which the specimen sample and the reference sample are respectively placed are housed in the heating furnace. Thereafter, the operator performs a predetermined operation through the operation panel to start the measurement.

### CITATION LIST

### Non Patent Literature

Non Patent Literature 1: “DTG-60/60H series, TG/DTA simultaneous measuring instrument”, [website], Shimadzu Corporation, [searched on Aug. 6, 2019], Internet

### SUMMARY OF INVENTION

### Technical Problem

As described earlier, in a conventional TG/DTA simultaneous measurement apparatus, it is required for an operator to put a tiny specimen sample and a reference sample on the sample plates before the measurement, and also to take them from the sample plates after the measurement. Specimen samples and reference samples are usually tiny and have a disc shape. Thus, it is difficult even for operators having experiences to skillfully hold the specimen samples and reference samples with tweezers. Furthermore, the sample plates are located at a relatively high position. Thus, it needs care to place the specimen sample and reference sample properly on the sample plates. In addition, it is also necessary to perform the operation without applying excessive force when a specimen sample and a reference sample are placed, in order to avoid the detectors from being bent or to prevent the weight measurement section from being broken. In view of such circumstances, the operation of placing or removing the specimen sample and the reference sample imposes an extreme burden on an operator, and the improvement in workability has been strongly demanded.

The present invention is made in view of the aforementioned problems. A main objective of the present invention is to provide a TG/DTA simultaneous measurement apparatus with improved workability in placing and removing, by an operator, the specimen sample and the reference sample on/from the sample plate.

### Solution to Problem

The present invention developed for solving the previously described problems is a TG/DTA simultaneous measurement apparatus that includes a heating furnace; a placing section configured to place, on its top portion, a tiny sample; a heating furnace moving section configured to move the heating furnace between a position where the placing section is housed in the heating furnace and a position where the placing section is exposed to the outside; and an operation assistance table made of a material having heat resistance, at a position lower than a position of the placing section, in front of the heating furnace, as viewed from a position of an operator who operates the TG/DTA simultaneous measurement apparatus.

### Advantageous Effects of Invention

In the TG/DTA simultaneous measurement apparatus according to the aforementioned aspect, the operation assistance table has two major functions: (i) a placing table for supporting the hand (in particular, a hypothenar eminence) of an operator when the operator picks a sample with tweezers to place the sample on the placing section, or when the operator picks the sample placed on the placing section with the tweezers; and (ii) a placing table for a specimen sample or a reference sample to be temporarily placed before or after the measurement.

In the TG/DTA simultaneous measurement apparatus according to the aforementioned aspect, the hypothenar eminence of the hand that holds the tweezers can be placed on and supported by the operation assistance table, when the operator places the sample on the placing section and removes the sample from the placing section. Accordingly, the position of the hand can be fixed, whereby precise operations including the placement of the sample on the placing section can be easily performed. Furthermore, as less burden is imposed on the hand, the operator can easily adjust his/her hand's force so that excessive force is not applied to the placing section, and the fatigue of the operator can be reduced.

Unwanted particles should be prevented from adhering to a sample before the analysis. In the TG/DTA simultaneous measurement apparatus according to the aforementioned aspect, a sample picked up by tweezers can be temporarily placed on a clean operation assistance table. Accordingly, contamination of the sample before the analysis can be prevented. Meanwhile, the temperature of the sample immediately after measurement is sometimes very high. Even in such a case, the temperature of the sample can be lowered by removing the hot sample from the placing section, and temporarily placing the sample on the operation assistance table having heat resistance. With such an operation, the workability in placing and removing the sample is improved.

### BRIEF DESCRIPTION OF DRAWINGS

FIG. 1A and FIG. 1B are respectively a top view and a side view, each showing the exterior of a TG/DTA simultaneous measurement apparatus according to an embodiment of the present invention.

FIG. 2 is a perspective view showing the exterior around an operation assistance table in the TG/DTA simultaneous measurement apparatus according to the present embodiment.

FIG. 3 is a perspective view showing a state where a sample is placed on a sample plate, in the TG/DTA simultaneous measurement apparatus according to the present embodiment.

FIG. 4 is a perspective view showing the exterior of a conventional TG/DTA simultaneous measurement apparatus.

### DESCRIPTION OF EMBODIMENTS

Hereinafter, a TG/DTA simultaneous measurement apparatus according to an embodiment of the present invention is described, with reference to the drawings.

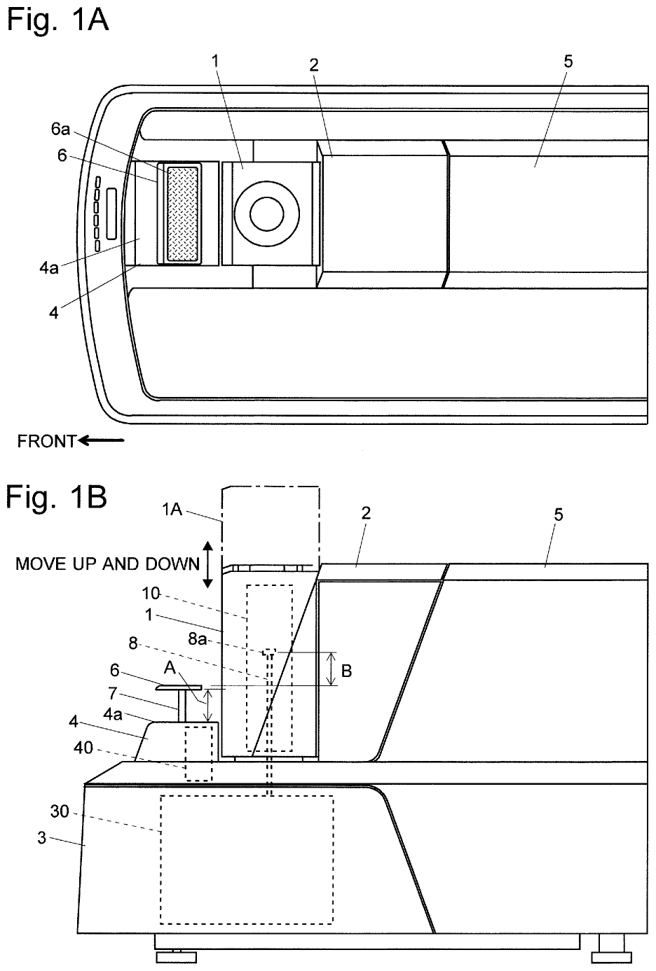

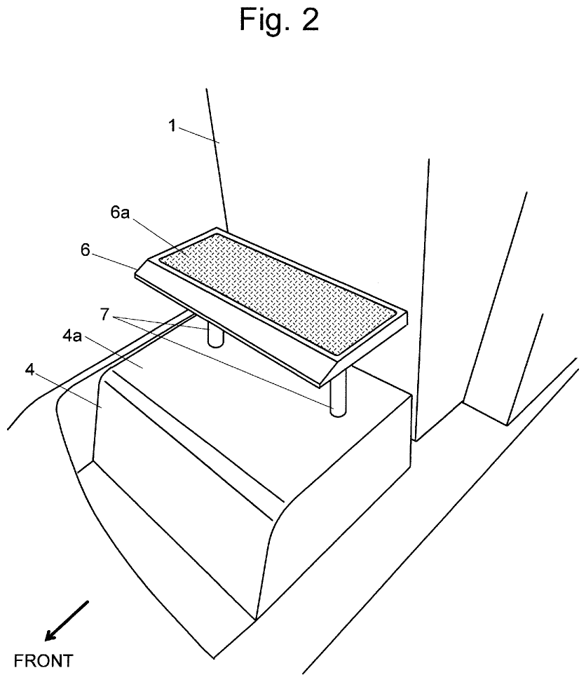

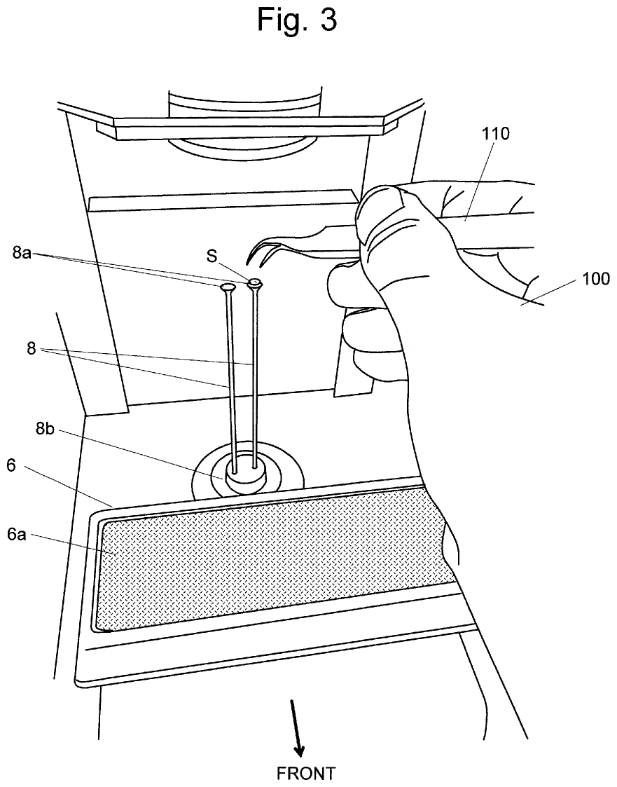

FIG. 1A and FIG. 1B are respectively a top view and a side view, each showing a TG/DTA simultaneous measurement apparatus according to the present embodiment. FIG. 2 is a perspective view of an operation assistance table in the TG/DTA simultaneous measurement apparatus according to the present embodiment. FIG. 3 shows a view of a state where a sample is placed on a sample plate, in the TG/DTA simultaneous measurement apparatus according to the present embodiment.

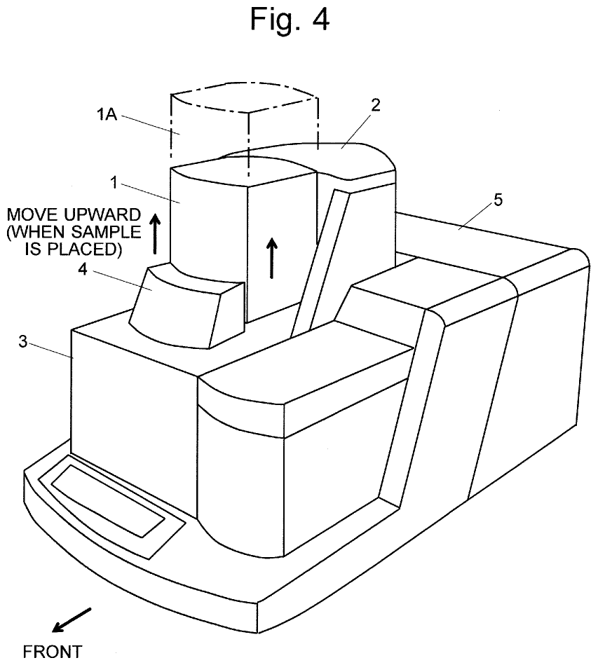

The TG/DTA simultaneous measurement apparatus according to the present embodiment is slightly different from the conventional apparatus shown in FIG. 4 in the exterior design, but is similar to the conventional one in the basic arrangement of each section. Specifically, the TG/DTA simultaneous measurement apparatus according to the present embodiment includes: in the lower part, a weight measurement section 3 containing a balance basis-weight section 30 for measuring the respective weights of a specimen sample and a reference sample; in the upper part, a heating furnace section 1 in which a heating furnace 10 is housed; and behind the heating furnace section 1, a heating furnace moving section 2 for moving the heating furnace section 1 upward and downward (the reference numeral 1A in FIG. 1B indicates a position of the heating furnace section 1 midway in the upward movement). Behind the heating furnace moving section 2, a controller 5 containing various electric circuits is provided. In the protruding portion on a casing of the weight measurement section 3 in front of the heating furnace section 1, there is provided a cooling section 4 which includes a fan 40 for cooling a connecting portion that connects the bottom of the heating furnace 10 and the balance basis-weight section 30.

In the state where the heating furnace 1 is moved upward to a predetermined position, two detectors 8 that extend upward via a connection portion 8b from the balance basis-weight section 30 positioned below the heating furnace 1 are exposed, as shown in FIG. 3. In the top of each detector 8, a sample plate 8a on which a specimen sample (and a reference sample) is to be placed is provided. The sample plate 8a is made of metal, such as platinum, for example, on the rear face of which a thermocouple for measuring the temperature is welded. The detectors 8 are made of an insulator, such as alumina, for example, and have the outer diameter of about 1.5 mm. Each of the detectors is provided with, in its inside, two longitudinal through-holes each of which has the diameter of about 0.4 mm. Through the two holes, conduction wires connected to the thermocouple are inserted.

In the TG/DTA simultaneous measurement apparatus according to the present embodiment, an operation assistance table 6 is provided above a flat top of a fan cover 4a of the cooling section 4, in front of the heating furnace section 1, as viewed from the operator of the present apparatus. The operation assistance table 6 is an approximately flat member made of a material having heat resistance and corrosion resistance, and is supported by two columns 7 standing parallel on the top of the fan cover 4a. Thus, between the top of the fan cover 4a and the operation assistance table 6, a space with a height (denoted by “A” in FIG. 1B) of about 40 mm is ensured. The space is designed for securing and admitting heat radiation from the operation assistance table 6 and from the fan cover 4a.

It is only required for a material of the operation assistance table 6 to satisfy the previously mentioned conditions. Here, the material in the present embodiment is stainless steel, and is formed in a predetermined shape by press molding. Specifically, the operation assistance table 6 has a front edge portion inclined downward from the back to the front, so that an operator can easily put his/her hand on the operation assistance table 6 from the front side. The operation assistance table 6 has a tray shape in which the center portion 6a is depressed by about 0.5 mm from its periphery. Surface processing for slip resistance is applied to the bottom surface of the center portion 6a, whereby the sample is prevented from slipping off the operation assistance table 6 when the sample is placed on the operation assistance table 6.

The position of the top surface of the operation assistance table 6 is lower than the position of the sample plates 8a at the top ends of the detectors 8 by a predetermined height (denoted by “B” in FIG. 1B). This height is determined so that the operator can easily place a sample on the sample plate 8a, or remove the sample from the sample plate 8a when his/her hand holding the tweezers is placed on the operation assistance table 6, as described later.

In the TG/DTA simultaneous measurement apparatus according to the present embodiment, as in the conventional apparatus, the heating furnace section 1 is moved upward to a predetermined position until the two sample plates 8a are exposed, and a specimen sample and a reference sample are placed on the sample plates 8a.

Specifically, the operator picks a sample S using precision tweezers 110 on an operation table (not shown), and puts his/her hypothenar eminence of the hand 100 holding the precision tweezers 110 on the right end of the operation assistance table 6 (in the case where the operator is right-handed), as shown in FIG. 3. Thus, the specimen sample (or the reference sample) picked up by the precision tweezers 110 is placed on the sample plate 8a while the hypothenar eminence is securely supported by the operation assistance table 6. It is also possible to temporarily put the sample S picked up with the precision tweezers 110 on the center part 6a of the operation assistance table 6 first, and then, place the hypothenar eminence of the hand 100 holding the precision tweezers 110 on the right end of the operation assistance table 6 and pick up the sample S on the operation assistance table 6 again with the precision tweezers 110. By keeping the top surface of the operation assistance table 6 clean, contamination of the temporarily-placed sample S is prevented.

As described so far, the hypothenar eminence of the hand 100 can be supported by the operation assistance table 6, whereby precise operations, such as placement of the small sample S on the sample plate 8a of the detector 8, can be easily performed. Furthermore, application of excessive force to the sample plate 8a can be avoided, whereby the detectors 8 and the balance basis-weight section 30 are prevented from being broken. In addition, the support by the operation assistance table 6 reduces the fatigue of the hand, whereby the operation efficiency is improved.

The temperature of the sample immediately after the measurement is sometimes very high. Such a hot sample can be taken out from the sample plate 8a, and placed one time on the center part 6a of the operation assistance table 6. The operation assistance table 6 is made of metal (stainless steel), and thus is not damaged even by such a hot sample. Furthermore, the operation assistance table 6 has a good heat releasing property. Accordingly, the temperature of the sample placed on the center part 6a rapidly lowers. After the temperature of the sample adequately lowers, the measured sample can be moved to another location.

It should be noted that the shape or the like of the operation assistance table 6 is not limited to the aforementioned embodiment.

In the TG/DTA simultaneous measurement apparatus according to the present embodiment, the cooling section 4 is located in front of the heating furnace section 1, and thus the operation assistance table 6 is attached to the top surface of the fan cover 4. When a cooling section having the same function as the cooling section 4 is located in the side of the heating furnace section 1 or other areas, the operation assistance table 6 is naturally attached to a different member.

Although the heating furnace section 1 moves upward and downward, in the TG/DTA simultaneous measurement apparatus according to the aforementioned embodiment, a configuration in which the heating furnace section moves in the horizontal direction has also been realized. Even in a TG/DTA simultaneous measurement apparatus having such a configuration, the same effect can be obtained by providing the operation assistance table at an appropriate position in front of the sample plate.

The aforementioned embodiment is an example of the present invention. It is apparent that any modification, correction, or addition within the scope of the present invention is included in the scope of claims of the present application.

[Various Aspects]

It is apparent for a person skilled in the art that the exemplary embodiment mentioned earlier is the specific example of the following aspects.

(First aspect) The first aspect of the TG/DTA simultaneous measurement apparatus according to the present invention includes: a heating furnace; a placing section configured to receive, on its top portion, a tiny sample; a heating furnace moving section configured to move the heating furnace between a position where the placing section is housed in the heating furnace and a position where the placing section is exposed to the outside; and an operation assistance table made of a material having heat resistance, at a position lower than a position of the placing section, in front of the heating furnace, as viewed from an operator who operates the TG/DTA simultaneous measurement apparatus.

In the TG/DTA simultaneous measurement apparatus according to the first aspect, the hypothenar eminence of the hand that holds the tweezers can be placed on and supported by the operation assistance table, when the operator places the sample on the placing section and takes the sample from the placing section. Accordingly, the position of the hand is effortlessly fixed during the operation, whereby detailed operations including the placement of the sample on the placing section can be easily performed. In addition, less burden is applied to the hand, whereby an operator can easily adjust his/her hand's force so that excessive force is not applied to the placing section, and the fatigue of the operator can be reduced.

In the TG/DTA simultaneous measurement apparatus according to the first aspect, a sample picked up by the tweezers can be temporarily placed on the clean operation assistance table. Therefore, the contamination of a sample before the analysis can be prevented by temporarily placing the sample on the casing of an apparatus, or the like. Meanwhile, the temperature of the sample immediately after the measurement is sometimes very high. Even in such a situation, the temperature of the sample can be decreased by taking the hot sample from the placing section, and temporarily placing the sample on the operation assistance table having the heat resistance. With such a configuration, the workability in placing and removing the sample can also be improved.

(Second aspect) In the TG/DTA simultaneous measurement apparatus according to the first aspect, the operation assistance table has a tray shape in which an overall top surface has an approximately planar shape, and a center portion of the top surface is depressed from the periphery.

In the TG/DTA simultaneous measurement apparatus according to the second aspect, when a sample is temporarily placed on the tray portion of the operation assistance table, the sample can be prevented from falling from the operation assistance table.

(Third aspect) In the TG/DTA simultaneous measurement apparatus according to the second aspect, the heating furnace moving section is configured to move the heating furnace upward and downward, and at least a part of a weight measurement section configured to measure a weight of the sample placed on the placing section is provided under the heating furnace, a fan configured to cool a connecting portion between the heating furnace and the weight measurement section is provided in front of the heating furnace in the side close to the bottom of the heating furnace, and the operation assistance table is provided above a fan cover in which the fan is housed.

In the TG/DTA simultaneous measurement apparatus according to the third aspect, a space above the fan cover can be effectively used. In addition, the length of the column that supports the operation assistance table can be short, whereby the strength of the operation assistance table is enhanced.

(Fourth aspect) In the TG/DTA simultaneous measurement apparatus according to the third aspect, the operation assistance table is held by a column standing on the top surface of the fan cover with a predetermined space from the top surface.

In the TG/DTA simultaneous measurement apparatus according to the fourth aspect, the space is defined between the operation assistance table and the fan cover, whereby the temperature of the hot sample is easily decreased when the hot sample is placed on the operation assistance table. In addition, heat generated by a fan surrounded by the fan cover is easily radiated to the outside.

(Fifth aspect) In the TG/DTA simultaneous measurement apparatus according to any one of the first to fourth aspects, the operation assistance table is made of a material having corrosion resistance.

(Sixth aspect) In the TG/DTA simultaneous measurement apparatus according to the fifth aspect, the operation assistance table is made of stainless steel.

In the TG/DTA simultaneous measurement apparatus according to the fifth and sixth aspects, even when a drug or the like is leaked from the sample placed on the operation assistance table, for example, contamination or damage of the operation assistance table itself can be restrained.

### REFERENCE SIGNS LIST

1 . . . Heating Furnace Section
10 . . . Heating Furnace
2 . . . Heating Furnace Moving Section
3 . . . Weight Measurement Section
30 . . . Balance Basis-Weight Section
4 . . . Cooling Section
40 . . . Fan
5 . . . Controller
8 . . . Detector
8a . . . Sample Plate
8b . . . Connecting Portion

1. A thermogravimetric/differential thermal analysis (TG/DTA) simultaneous measurement apparatus comprising:
a heating furnace;
a placing section configured to receive, on its top portion, a tiny sample;
a heating furnace moving section configured to move the heating furnace between a position where the placing section is housed in the heating furnace and a position where the placing section is exposed to an outside; and
an operation assistance table made of a material having heat resistance, at a position lower than a position of the placing section, in front of the heating furnace, as viewed from an operator who operates the TG/DTA simultaneous measurement apparatus.

2. The TG/DTA simultaneous measurement apparatus according to claim 1, wherein
the operation assistance table has a tray shape in which an overall top surface has an approximately planar shape, and a center portion of the top surface is depressed from a periphery.

3. The TG/DTA simultaneous measurement apparatus according to claim 2, wherein
the heating furnace moving section is configured to move the heating furnace upward and downward,
at least a part of a weight measurement section configured to measure a weight of the sample placed on the placing section is provided under the heating furnace,
a fan configured to cool a connecting portion between the heating furnace and the weight measurement section is provided in front of the heating furnace in a side close to a bottom of the heating furnace, and
the operation assistance table is provided above a fan cover in which the fan is housed.

4. The TG/DTA simultaneous measurement apparatus according to claim 3, wherein
the operation assistance table is held by a column standing on a top surface of the fan cover with a predetermined space from the top surface.

5. The TG/DTA simultaneous measurement apparatus according to claim 1, wherein
the operation assistance table is made of a material having corrosion resistance.

6. The TG/DTA simultaneous measurement apparatus according to claim 5, wherein
the operation assistance table is made of stainless steel.

7. The TG/DTA simultaneous measurement apparatus according to claim 4, wherein
the operation assistance table is made of a material having corrosion resistance.

8. The TG/DTA simultaneous measurement apparatus according to claim 7, wherein
the operation assistance table is made of stainless steel.
